(19) United States
(12) Patent Application Publication
(10) Pub. No.: US 2011/0234377 A1
(43) Pub. Date: Sep. 29, 2011

(54) Method and apparatus for identifying an RFID type

(75) Inventors: Richard William Landuyt, Arlington Heights, IL (US); Gregory James Gliniecki, Cary, IL (US); Michael H. Katz, Glen Ellyn, IL (US); Edward Johann March, JR., Barrington, IL (US)

(73) Assignee: RF IDeas, Inc., Schaumburg, IL (US)

(21) Appl. No.: 13/065,550

(22) Filed: Mar. 23, 2011

Related U.S. Application Data
(60) Provisional application No. 61/316,708, filed on Mar. 23, 2010.

(51) Int. Cl. H04Q 5/22

(52) U.S. Cl. 340/10.1

(57) ABSTRACT

An apparatus is disclosed for use in interrogating a RF signal. The apparatus includes a reader module that determines the transmitted RFID information associated with the RF signal based on tag type parameters associated with a first RFID tag type. The apparatus further includes a validation module that compares at least a portion of the transmitted RFID information with an expected characteristics associated with the RFID tag type to determine if the RF signal was transmitted by a RFID tag associated with the RFID tag type. The apparatus may also include a tag type selector module that determines the tag type parameters used by the reader module.

### PRIORITY

This application claims priority from and the benefit of U.S. Provisional Patent Application No. 61/316,708, filed Mar. 23, 2010, entitled “Method and Apparatus for Determining RFID Parameters”, which is hereby incorporated herein by reference in its entirety.

### FIELD

The present disclosure generally relates to products that include radio frequency identification (“RFID”) information, and more particularly, to readers capable of reading RFID information from radio frequency (“RF”) signals.

### BACKGROUND

RFID technology is widely used in a variety of applications. A basic RFID system includes a RFID tag and a RFID reader. RFID tags generally include a microchip attached to a radio antenna mounted on a substrate. The chip may include certain information or data (i.e., “RFID information”) that will be transmitted when the RFID tag is activated.

RFID readers generally include an antenna that emits radio waves or signals at a specified frequency, as set by an oscillator. In essence, the emitted radio waves or signals from a RFID reader provide electromagnetic energy within a close range of the RFID reader. When a passive RFID tag passes through the electromagnetic zone, it receives power from the RFID reader's emitted RF signal and modifies the RF signal by modulating the amplitude thereof. This modified RF signal is detected at the antenna of the RFID reader. The RFID reader's emitted RF signal can be conceptualized as an outbound or reader's RF signal and the modified RF signal at the RFID reader's antenna can be conceptualized as the inbound or tag's RF signal.

The RFID reader then performs demodulation and/or decoding on the inbound RF signal to obtain the transmitted RFID information in the tag's RF signal. This RFID information can be used by a system to suit the needs of any number of applications. For example, the RFID information transmitted by the RFID tag may provide identification or location information or specifics about the product tagged, such as price, color, date of purchase, etc.

A RFID tag can be incorporated in a variety of objects such as, for example, a product, an animal, and/or other suitable object. Many modern access control cards include RFID tags, which can be used to obtain access to buildings. These cards are becoming more popular for uses outside traditional physical access control. Products such as RF IDeas pcProx and AIR ID readers allow these access cards to be used for other forms of identification and authentication. These include, but are not limited to, computer logon, time and attendance, secure printing, point of sale, manufacturing, PLC logon, visitor management where the end users desire to use their current access control cards as a form of identification or authentication over other methods such as PINs, passwords, biometrics or other credentials.

There are many manufacturers of cards with RFID tags. Generally, each manufacturer employs RFID tags that are configured to operate at unique frequencies, modulate types or schemes and encoding types or schemes. As such, end users and third parties that develop solution's wishing to support access control cards that employ these RFID tags are often challenged to determine what card type or tag type the user actually uses at their facility so that the proper reader can be purchased and deployed. As such, there is a need for a method and apparatus that is capable of overcoming the aforementioned disadvantages.

Similarly, there is a need for a universal or auto-typing RFID reader that is capable of reading various types of RFID tags and then automatically configuring itself to always read that type of RFID tag using that tag type's parameters (e.g., carrier frequency, modulation type and encoding type).

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 is an exemplary functional block diagram of a radio frequency identification system including a RFID tag, a RFID tag analyzer and a host computing device;

FIG. 2 is a flowchart depicting exemplary operations that can be performed by the RFID tag analyzer of FIG. 1;

FIG. 3 is a flowchart depicting additional exemplary operations that can be performed by the RFID tag analyzer of FIG. 1 and/or the RFID helper module of FIG. 1;

FIG. 4 is an exemplary functional block diagram of a radio frequency identification system including a RFID tag, a configurable RFID reader and a host computing device;

FIG. 5 is a flowchart depicting exemplary operations that can be performed by the data format customizer module of FIGS. 1 and 4;

FIG. 6 is an exemplary functional block diagram of a RFID auto-typing reader and a RFID tag;

FIG. 7 is a flowchart depicting exemplary operations that can be performed by the RFID auto-typing reader of FIG. 6;

FIGS. 8-11 are flowcharts depicting exemplary operations that can be performed by the communication modules of FIGS. 1, 4 and 6.

### DETAILED DESCRIPTION

As used herein, the term “circuit” and/or “module” can include an electronic circuit, one or more processors (e.g., shared, dedicated, or group of processors such as but not limited to microprocessors, DSPs, or central processing units) and memory that execute one or more software or firmware programs, combinational logic circuits, an application specific integrated circuit, and/or other suitable components that provide the described functionality. Additionally, the term “signal” may refer to one or more currents, one or more voltages, or a data signal. Furthermore, as will be appreciated by those of ordinary skill in the art, the layout of a “circuit” and/or “module” can be described and laid out in a hardware description language such as Verilog™, VHDL, and/or other suitable hardware description languages. Additionally, those of ordinary skill in the art will appreciate, the layout of a “circuit” and/or “module” can be described and laid out in a schematic and/or circuit board layout such as PCAD, Pads-PCB, and other suitable schematic and/or circuit board layout applications. As used herein, a “computing device” is any device that is capable of computing data such as but not limited to a personal computer or any circuit or module.

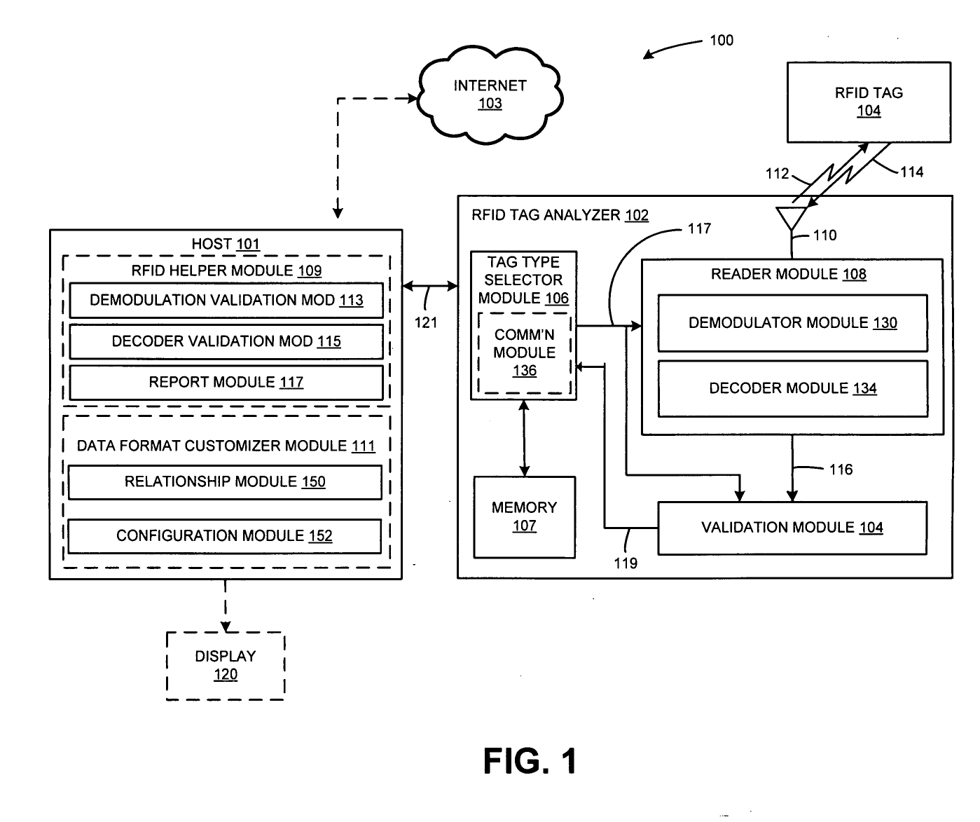

Referring now to FIG. 1, an exemplary functional block diagram of a radio frequency identification system 100 including a RFID tag 104, a RFID tag analyzer 102 and a host computing device 101 is illustrated. The RFID tag 104 can be any known RFID device such as a proximity card, a contactless card, a fob, an adhesive label, an inlay, and/or other suitable RFID device. An example of the RFID tag 104 is described in U.S. Pat. No. 5,347,263 and U.S. Pat. App. Pub. No. 2008/0272892 both of which are incorporated by reference in their entireties.

RFID tag analyzer 102 includes an antenna circuit 110, a card type selector module 106, a reader module 108, a validation module 104 and memory 107. The RFID tag analyzer 102 transmits an outbound RF signal 112 via the antenna circuit 110 using known techniques. For example outbound RF signal 112 may be modulated in any suitable manner known in the art such as, for example, using amplitude shift keying modulation, phase shift keying modulation, frequency keying, modulation, and/or other suitable modulation. In addition, the outbound RF signal 112 can be at any suitable carrier frequency such as 125 kHz or 13.56 MHz for example and can be encoded in any suitable manner such as using a non-return-to-zero inverted (NRZI) encoding scheme or a Manchester encoding scheme. In one embodiment, the RFID tag analyzer 102 can transmit multiple outbound RF signals 112 for multiple card technologies. For example, in one embodiment, the RFID reader module 108 can simultaneously transmit one outbound RF signal 112 at a first carrier frequency (e.g., 125 kHz) and another outbound RF signal 112 at a second carrier frequency (e.g., 13.56 MHz). Other carrier frequencies are contemplated.

The outbound RF signal 112 activates the RFID tag 104 and causes the RFID tag 104 to generate a inbound RF signal 114 at the antenna 110. The reader module 108 is instructed by the tag type selector 106 to attempt to demodulate and, if necessary, decode the inbound RF signal 114 using a first set of tag type parameters. In one embodiment, the first set of tag type parameters includes a first demodulation type or scheme, a first carrier frequency and a first decoding type or scheme that are associated with a first RFID tag type.

As described above, manufacturers of RFID tags generate inbound RF signals 114 using unique tag parameters. For example, RFID tags produced by manufacturer “A” and manufacturer “B” will generate different “types” of inbound RF signals as a result of each manufacturer using a unique combination of modulation type or scheme, carrier frequency and encoding type or scheme. Consequently, an inbound RF signal from a RFID tag made by manufacturer “A” will require use of a unique set of tag type parameters to obtain the transmitted RFID information present in the inbound RF signal. Similarly, an inbound RF signal from a RFID tag made by manufacturer “B” will require use of a different set of tag type parameters to obtain the transmitted RFID information present in the inbound RF signal.

In one embodiment, the tag selector module 106 may provide the first set of tag parameters by looking up the first RFID tag type in memory 107 and passing to the reader module 108 a signal 117 that instructs the reader module 108 to use the first set of parameters that are associated with the first RFID tag type. In one embodiment, the instruction passed to the reader module 108 may constitute a hexadecimal number representing the first set of parameters.

Reader module 108 includes a demodulator module 130 and decoder module 134, which respectively operate to demodulate the inbound RF signal 114 using the first demodulation type or scheme and to decode, if necessary, the demodulated inbound RF signal 114 using the first decoding type or scheme. The captured, demodulated and decoded inbound RF signal 116 may take the form of a digital data stream and constitutes the transmitted RFID information associated with inbound RF signal 114. As will be appreciated in the art, signal 116 constitutes the transmitted RFID information from the RFID tag.

Validation module 104 receives signal 116 and also receives the first set of tag type parameters (e.g., from signal 117). Using the first set of tag type parameters, validation module 104 obtains an expected characteristic(s) of the transmitted RFID information that is associated with the RFID tag type to which the first set of tag type parameters correspond. Validation module 104 then compares at least a portion of the transmitted RFID information with an expected characteristic(s) of the transmitted RFID information to determine if the inbound RF signal 114 was transmitted by a RFID tag associated with the first RFID tag type. One having ordinary skill in the art will recognize that the expected characteristic(s)s may vary from tag type to tag type and that various “characteristics” such as size, format, bits, etc., may be utilized for this comparison.

If the validation module 104 determines that the inbound RF signal 114 was transmitted by a RFID tag associated with the first RFID tag type, it notifies tag type selector module 136 via signal 119. In response, tag type selector module 136 configures an output signal 121 to a host computing device 101. Output signal 121 may be configured to include any or all of the following information:

Textual information describing the type of RFID tag type (e.g., this is a HID type RFID tag);

Part number information associated with a RFID reader that can read inbound RF signals produced by the RFID tag (e.g., actual or OEM part numbers);

Information regarding the transmitted RFID information (e.g., the types of information present in the transmitted RFID information); and

The transmitted RFID information itself, or a portion thereof (e.g., a facility code and/or an identification code).

Output signal 121 may include other information that is representative of the RFID tag type. One having ordinary skill in the art will appreciate that the tag type selector module 106 may be programmed or modified to generate an output signal 121 containing portions or all of the above-identified information.

In one embodiment, RFID tag analyzer 102 is a keyboard emulator and the output signal 121 is a data stream of keystroke information. The keyboard emulator may, for example, constitute a USB keyboard emulator or a PS/2 keyboard emulator. In this embodiment, host computing device 101 is a personal computer. Output signal 121 is written to a text editor associated with computing device 101 (such as Microsoft Notepad) as directed by the tag type selector module 106 or is printed to a display such as optionally coupled display device 120. Display 120 can comprise any suitable display such as a monitor, computer and monitor combination, laptop, handheld device, embedded device, PDA, cell phone, thin client, media player and/or other suitable display methodology.

If, however, the validation module 104 determines that the inbound RF signal 114 was not transmitted by a RFID tag associated with the first tag type, the validation module 104 notifies the tag type selector module 106 of this condition. In response, the tag type selector module generates a second set of tag type parameters and instructs the reader module 108 to again demodulate and/or decode the inbound RF signal 114 using the second set of tag type parameters in the same manner as described above with the first set of tag type parameters.

As described above, the second set of tag type parameters may be “generated” by the tag type selector module 106 by accessing memory 107 and providing signal 117 to the reader module 108. In return, reader module 108 generates a new transmitted RFID information 116 using the second set of tag type parameters and passes the new transmitted RFID information 116 to validation module 104.

Validation module 104 obtains an expected characteristic(s) of the transmitted RFID information that is associated with the RFID tag type to which the second set of tag type parameters correspond and compares at least a portion of the new transmitted RFID information with an expected characteristic(s) of the transmitted RFID information to determine if the inbound RF signal 114 was transmitted by a RFID tag associated with the RFID tag type. The process continues until a valid tag type is found or the tag type selector module 106 has exhausted all known sets of tag type parameters (e.g., as stored in memory 106).

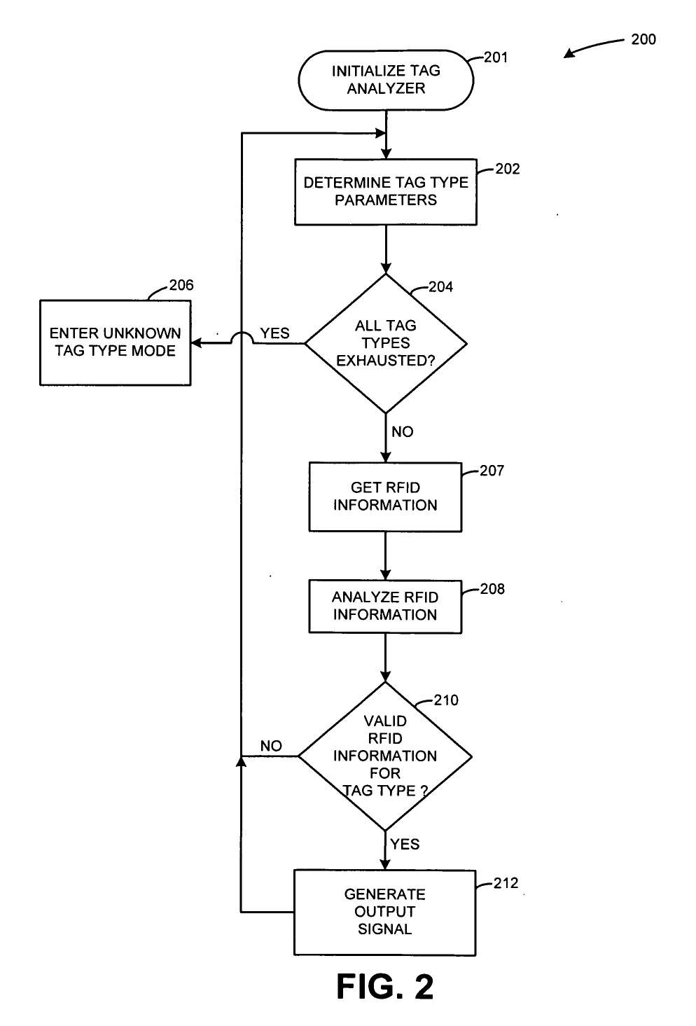

FIG. 2 is a flowchart 200 depicting exemplary operations that can be performed by the RFID tag analyzer 102 of FIG. 1. The RFID tag analyzer 102 is initialized in 201 by, for example, sensing that the scroll lock key or caps lock key is pressed on a keyboard (not shown) associated with host 101. In 202, tag type parameters are obtained by the tag type selector module 106 (e.g., by accessing memory 107). Tag type selector module 106 maintains an understanding of which tag type parameters have been previously obtained for each inbound RF signal 114 for the purpose of subsequently determining (if necessary) whether all known sets of tag type parameters have been exhausted. Hence, in 204, the method determines (e.g., by tag type selector module 106) whether it has already obtained all known tag type parameters (e.g., as found in a table in memory 107).

During the first pass through method 200, the determination at 204 is, by definition, “no”. The method continues in 207 where the reader module 108 obtains the inbound RF signal 114 and obtains the transmitted RFID information using tag type parameters. In block 208, the transmitted RFID information is analyzed using, for example, validation module 104. As described above, validation module 104 then determines whether the transmitted RFID information is valid based on a comparison of at least a portion of the transmitted RFID information with an expected characteristic(s) associated with the RFID tag type to which the tag type parameters correspond.

If the determination is negative, the method is directed to block 202 and the tag type selector module 106 obtains or determines a new set of tag type parameters for the reader module 108 and validation module 104 as described above. If the determination is positive, the method proceeds to 212 where an output signal is generated (e.g., output signal 121 as generated by tag type selector module 106). In one embodiment, the method is then directed to block 202 and the tag type selector module 106 obtains or determines a new set of tag type parameters for the next RFID tag 104 in proximity. Alternatively, the method may end (not shown).

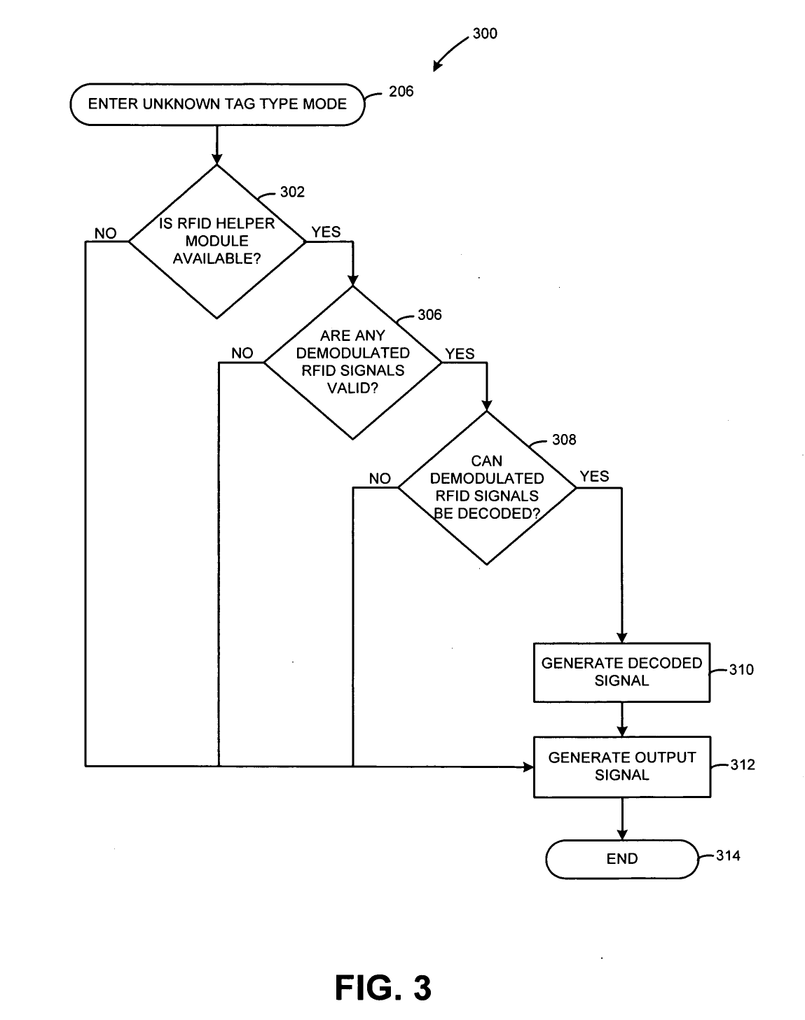

Returning to block 204, if the determination is “yes” (i.e., it is determined that all known tag parameter have been “analyzed” and therefore exhausted), the method continues to 206 and enters an “unknown tag type mode” as described with reference to FIGS. 1 and 3.

With reference to FIG. 3, flowchart 300 depicts additional exemplary operations are illustrated that can be performed by the RFID tag analyzer 102 of FIG. 1 and the RFID helper module 109 of FIG. 1. The method begins at 206 with unknown tag type mode being entered by, for example, the tag type selector module 106. (See FIG. 2 206). The method continues with 302 where the tag type selector module 106 determines whether the RFID helper module is available. With reference to FIG. 1, the RFID helper module 109 may be part of a host computing device 101 such as a personal computer. In one embodiment, the RFID helper module 109 may consist of a software application installed on the personal computer. The tag type selector module 106 may make this determination using conventional means.

If the determination is negative, the method proceeds to 312 where an output signal is generated by, for example, the tag type selector module 106. In one embodiment, the output signal may correspond to output signal 121 and may indicate that the inbound RF signal 114 was not capable of being read.

If the determination is positive, the method proceeds to 306 where control of the RFID tag analyzer 102 passes to the RFID helper module 101. Control may pass using any conventional means. For example, the tag type selector module 106 may generate an output signal corresponding to output signal 121 indicating that the inbound RF signal 114 should be analyzed by RFID helper module 109. Thereafter, the RFID helper module 109 and its constituent parts may have control over each of the constituent components of RFID tag analyzer 102 (e.g., tag type selector module 106 and reader module 108).

RFID helper module 109, and specifically demodulation validation module 113 exercises its control by determining whether any of the demodulated RFID signals obtained by demodulator module 130 based on the known tag type parameters are valid. If the determination is negative, the method continues to 312 and generates an output signal. The output signal may be generated by report module 117. The output signal may indicate that the inbound RF signal 114 was not capable of being read. If, however, the determination is positive, the method continues to 308.

There the method determines whether the demodulated RFID signals can be decoded. In one embodiment, decoder validation module 115 carries out this method. Decoder validation module 115 may, in one embodiment, be a faster, more efficient version of decoder module 134 or may have greater intelligence to ascertain other less common decoding schemes used by RFID tags. If the determination is negative, the method continues to 312 where an output signal is generated (e.g., by report module 117). The output signal may indicate that the inbound RF signal 114 was not capable of being read. If, however, the determination is positive, the method continues to 310.

In 310, the demodulated RFID signal is decoded (e.g., by the decoder validation module 134). The process then continues to 312 where an output signal is generated (e.g., by report module 117). The output signal may be configured to include any or all of the following information:

Textual information describing the type of RFID tag type (e.g., this is a HID type RFID tag);

Part number information associated with a RFID reader that can read inbound RF signals produced by the RFID tag (e.g., actual or OEM part numbers);

Information regarding the transmitted RFID information (e.g., the types of information present in the transmitted RFID information); and

The transmitted RFID information itself, or a portion thereof (e.g., a facility code and/or an identification code).

Thereafter, the method concludes at 314.

One of ordinary skill in the art will appreciate that the output signals capable of being generated at 312 may be written to memory, to a text editor (e.g., Microsoft Notepad), printed to display device 120, sent via email, etc. The report module 117 may be configured to send the output signal via email over the Internet 103 (FIG. 1) to a customer service center that can better analyze the demodulated RFID signal associated with inbound RFID signal 114.

Returning to FIG. 1, host computing device 101 may also include data format customer module 11. Data format customizer module 111 includes a relationship module 150 and a configuration module 152. In one embodiment, the relationship module 150 prompts a user of the host computing device 101 to enter an expected data result. This may be performed in response to identifying an RFID tag 104 as belonging to a particular tag type (as would be indicated on output signal 121).

The expected data result represents the form of the transmitted RFID identification associated with inbound RF signal 114 from the same RFID tag 104 that the user “expects” or “desires” to see each time the RFID tag 104 is read by a RFID reader. One of ordinary skill in the art will recognize that this expected data result may be useful for interoperability with existing systems employed by the user that utilize RFID tag 104.

Upon obtaining output signal 121 identifying an RFID tag type, the relationship module 150 determines a relationship between the expected data result entered by the user of the host computing device 101 and the actual data result (e.g., the transmitted RFID information associated with the inbound RF signal 114 from the RFID tag 104). Any number of relationships may exist such as, but not limited to, converting the actual data result to decimal and dropping a leading bit, inverting the actual data result, shifting the actual data result, etc.

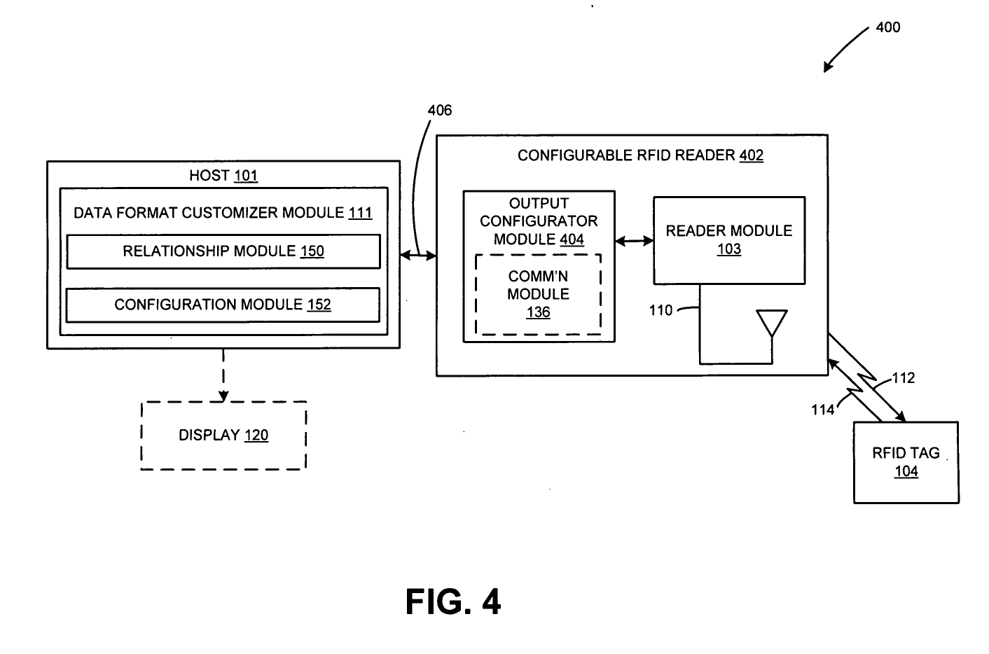

The configuration module 152 may generate a configuration file with an algorithm based on the determined relationship that can be used by a configurable RFID reader to output the expected data result each time such a reader obtains the actual data result from the RFID tag 104. For example, and with reference to FIG. 4, a configurable RFID reader 402 is illustrated. The configuration module 152 may generate a suitable configuration file (not shown) that is capable of being interpreted by the output configurator module 404 such that each time reader module 103 reads the actual data result from the RFID tag 104, the output configurator module 404 follows the algorithm and returns to the host computing device 101 output signal 406 as the expected data result.

Alternatively, the configuration module 152 may automatically configure the output configurator 404 if the configurable RFID reader 402 is coupled to the host computing device 101.

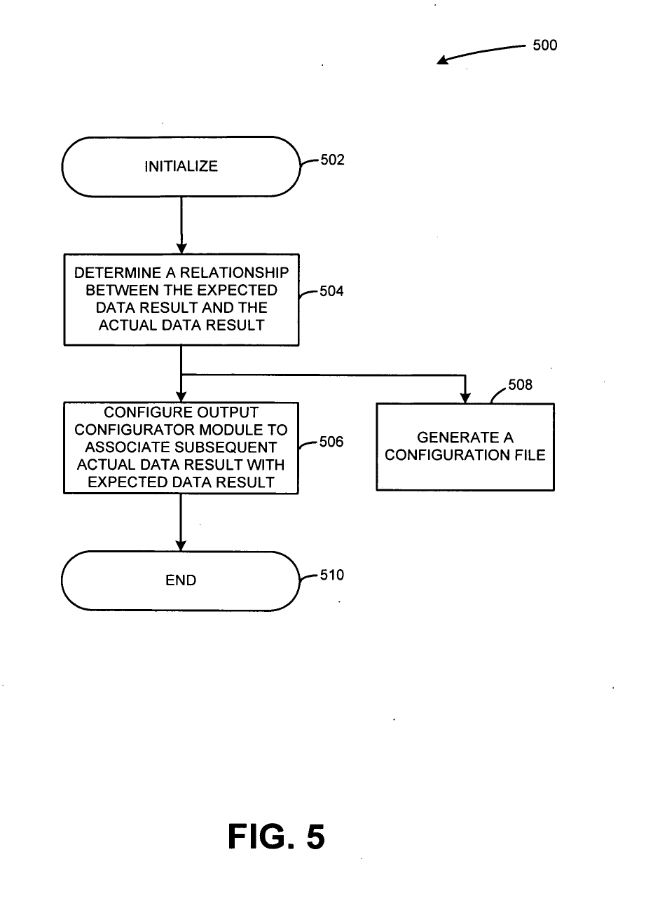

With reference to FIG. 5, flowchart 500 depicting exemplary operations are illustrated that can be performed by the data format customizer module 111 of FIGS. 1 and 4. The method begins in 502. For example, the method may be commenced in response to a determination of a RFID tag type as indicated in output signal 121. The method continues to 504 where a relationship is determined between the expected data result and the actual data result. In one embodiment, this may be performed by the relationship module 150 as described above. The method then continues to block 506 or block 508 where either configuration file is generated 508 or an output configurator module (e.g., 404) associated with t configurable RFID reader (e.g., 402) is configured. In one embodiment, this may be performed by the configuration module 152. Thereafter, the method concludes with 512.

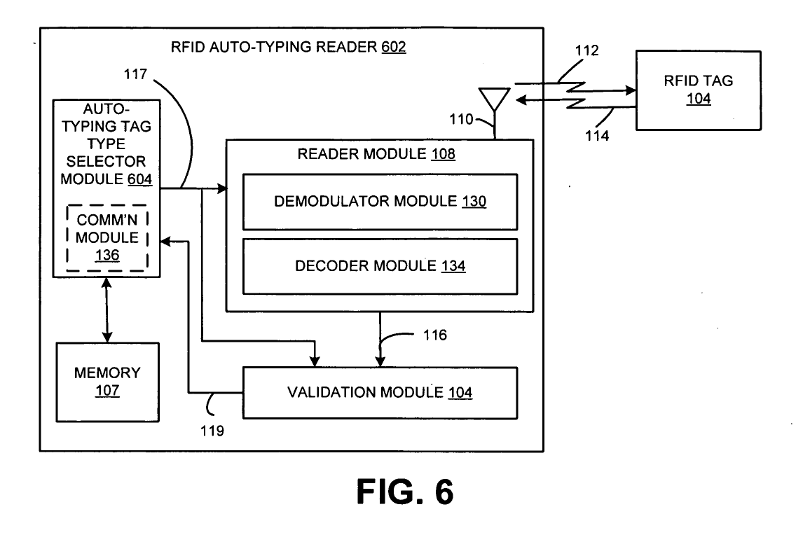

With respect to FIG. 6, an exemplary functional block diagram 600 of a RFID auto-typing reader 602 and a RFID tag 104 is illustrated. The RFID auto-typing reader 602 includes the same components as the RFID tag analyzer 102 with one exception. Instead of including a tag type selector module 106, the RFID auto-typing reader 602 includes an auto-typing tag type selector module 604.

In operation, the auto-typing tag type selector module 604 includes the functionality of the tag type selector module 106, and also has the ability to set or configure the reader module 108 and the validation module 104 with a RFID tag type associated with the first or initial tag type the reader module 108 encounters and successfully reads. In this regard, the RFID auto-typing reader 602 serves as a type of universal reader. When an RFID tag 104 is within a predetermined proximity to the RFID auto-typing reader 602, the RFID auto-typing reader 602 functions to ascertain the tag type associated with the RFID tag 104 in the same manner as described with respect to FIG. 1. Once the tag type is identified and the auto-typing tag type selector module 604 is notified via signal 119, the auto-typing tag type selector module 604 configures the reader module 108 and the 104 with the tag parameters necessary to read RFID tags of the type just identified.

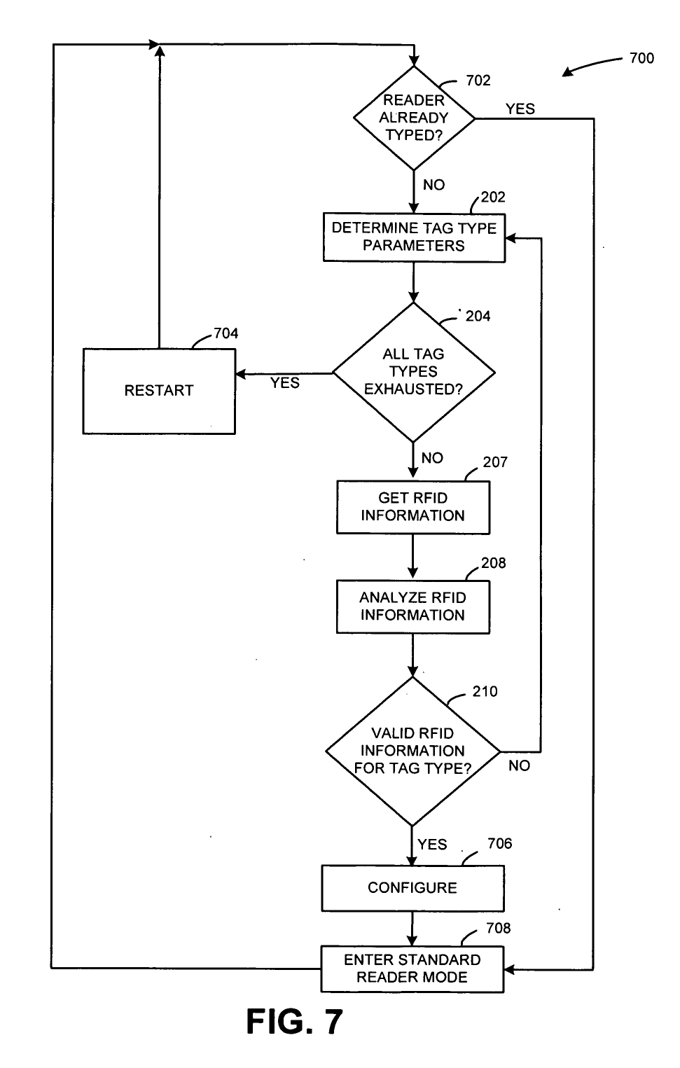

FIG. 7 is a flowchart 700 depicting exemplary operations that can be performed by the RFID auto-typing reader 602 of FIG. 6. The method begins at 702 where it is determined whether the RFID auto-typing reader 602 is already typed. This may be performed by the auto-typing tag type selector module 604. If the determination is positive, the RFID auto-typing reader 602 has already been configured for a particular type of RFID tag 104 and the RFID auto-typing reader 602 enters standard reader mode 708.

If, however, the determination is negative, the method continues to block 202, 204, 207, 208 and 210, which were previously described with respect to FIG. 2 with two exceptions. First, if the determination of 204 is yes, the method proceeds to 704 which restarts the method at 702. In other words if auto-typing tag type selector module 604 determines that it has exhausted all tag types in 204, it simply starts the process over with the first tag type used. If the tag type parameters are stored in memory (e.g., memory 107) as a table, 704 corresponds to starting the process 700 with the auto-typing tag type selector module passing the first set of tag type parameters from the “top” of the table.

Second, if the transmitted RFID information for the tag type is determined to be valid (i.e., a “yes” determination from 210), the method continues with configuring the reader module 108 and the validation module 104 to always use the same set of tag type parameters in “reading” all incoming RF signals 114. This may be accomplished, e.g., by storing the tag type parameters to memory (e.g., memory 107). After 706, the method proceeds to 708 and the RFID auto-typing reader 602 is placed in standard reader mode.

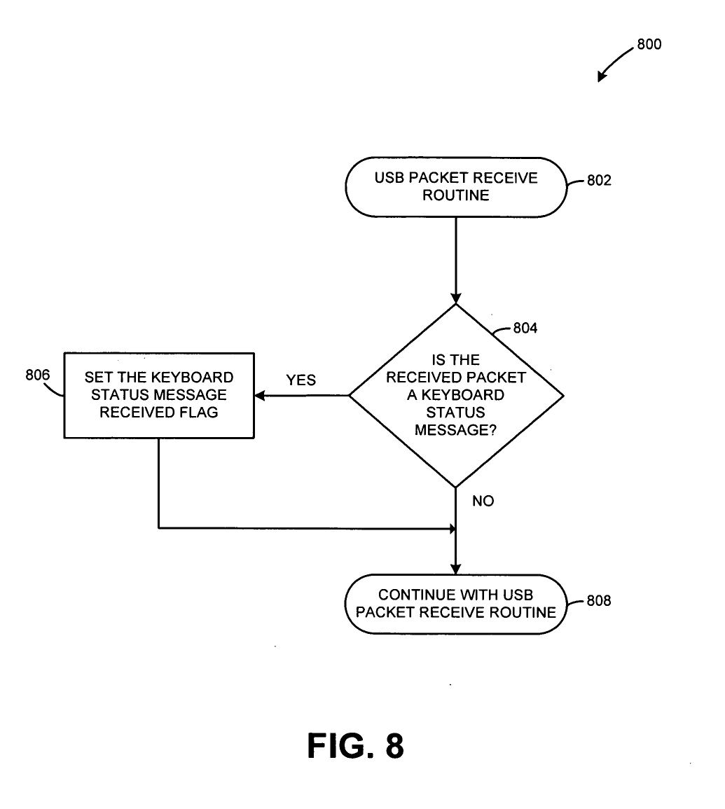

FIGS. 8-11 are flowcharts 800-1100 depicting exemplary operations that can be performed by the communication module 136 of FIGS. 1, 4 and 6. As illustrated in FIGS. 1, 4 and 6, the communication module 136 may be a constituent part of the tag type selector module 106, the output configurator module 404 and/or the auto-typing tag type selector module 604. The manner in which the communication module 404 functions is identical. Accordingly, the communication module 404 will be described with respect to the tag type selector module 106 in FIG. 1.

With reference to FIG. 8, exemplary operations 800 capable of being performed by the communication module 136 of FIG. 1 are illustrated. The exemplary operations 800 may commence with 802 whenever the communication module 136 receives a USB packet from the host computing device 101 (e.g., following or during keyboard enumeration with the host 101). In this example, the RFID tag analyzer 102 is a USB keyboard emulator capable of being coupled to a personal computer (e.g., host computing device 101). The method continues with 804 where it is determined if the received packet is a keyboard status message. A keyboard status message represents the current state of the caps lock, scroll lock and num lock keys for the operating system. It is recognized, however, that not all operating systems or capable of generating keyboard status messages (e.g., Mac OS X does not support such messages). Determining whether a keyboard status message has been received may be made using conventional methods.

If the determination is positive, the method continues to 806 where a keyboard status message received flag is set (e.g., populating memory with a predetermined bit that represents the receipt of a keyboard status message). If the determination is negative, the method simply ends at 808 and continues by, for example, receiving USB packets from the host 101.

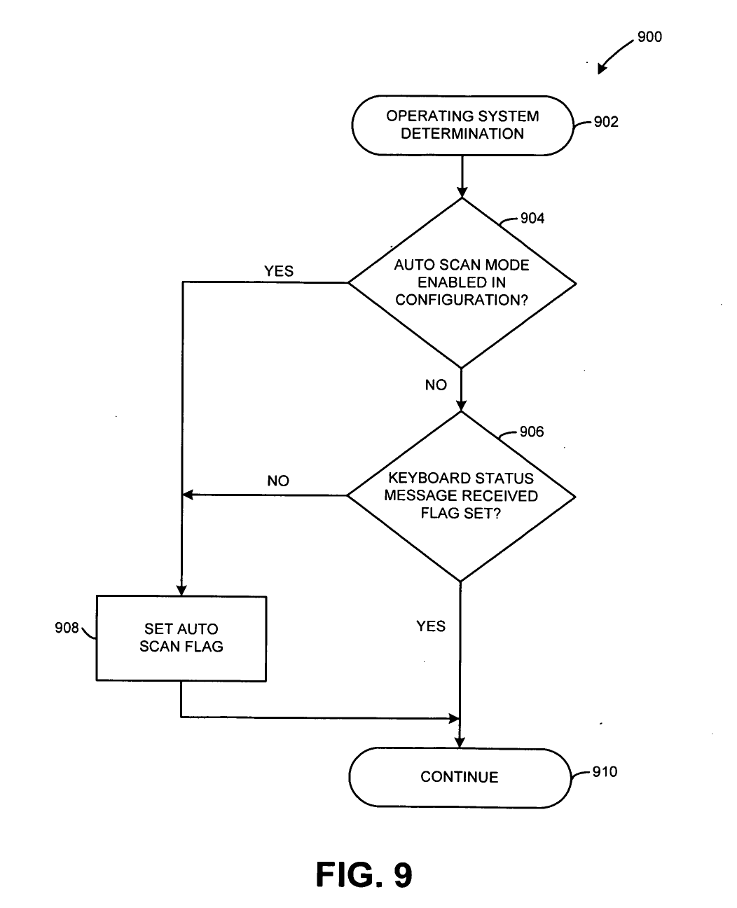

With reference to FIG. 9, exemplary operations 900 for determining the type of operating system installed on the host computing device 101 are illustrated. Exemplary operations 900 are capable of being performed by the communication module 136 of FIG. 1. The method begins with block 902 as part of the normal power up procedure of the RFID tag analyzer 102, specifically as part of the post enumeration process between the RFID tag analyzer 102 and the host computing device 101.

The method continues with 904 where a determination is made as to whether the RFID tag analyzer 102 has already been configured to start its operations in auto-scan mode (i.e., to automatically being scanning for RFID tags 104 within proximity and to attempt to identify the RFID tag's type). The determination, in one embodiment, is made by looking at a configuration file stored in memory (e.g., memory 107). If the determination is positive, a auto scan flag is set in 908 (e.g., in memory such as 107). The method then concludes with 910. If the auto scan flag is set, the RFID tag analyzer 102 is initialized (see 201 in FIG. 1) and is configured to automatically start scanning for RFID tags 104 after a predetermined period of time. The method then concludes with 910.

If, however, the determination at 904 is negative, the method continues with 906 where it is determined if the keyboard status message received flag is set in memory (e.g., memory 107). As previously discussed with reference to FIG. 8, the keyboard status message received flag may be set in 806. If the determination is negative, the operating system of the host 101 does not support global keyboard messages (e.g., Mac OS X), and the method continues with 908 and 910 as discussed above.

If, however, the determination, is positive, the operating system of the host 101 does support global keyboard messages (e.g., Microsoft Windows 7), the power up sequence continues with 910. Upon completion, the RFID tag analyzer 102 is configured to either initialize automatically (after a predetermine period of time) or to initialize upon, for example, a user depressing a scroll lock key or caps lock key on the keyboard (not shown) association with host 101.

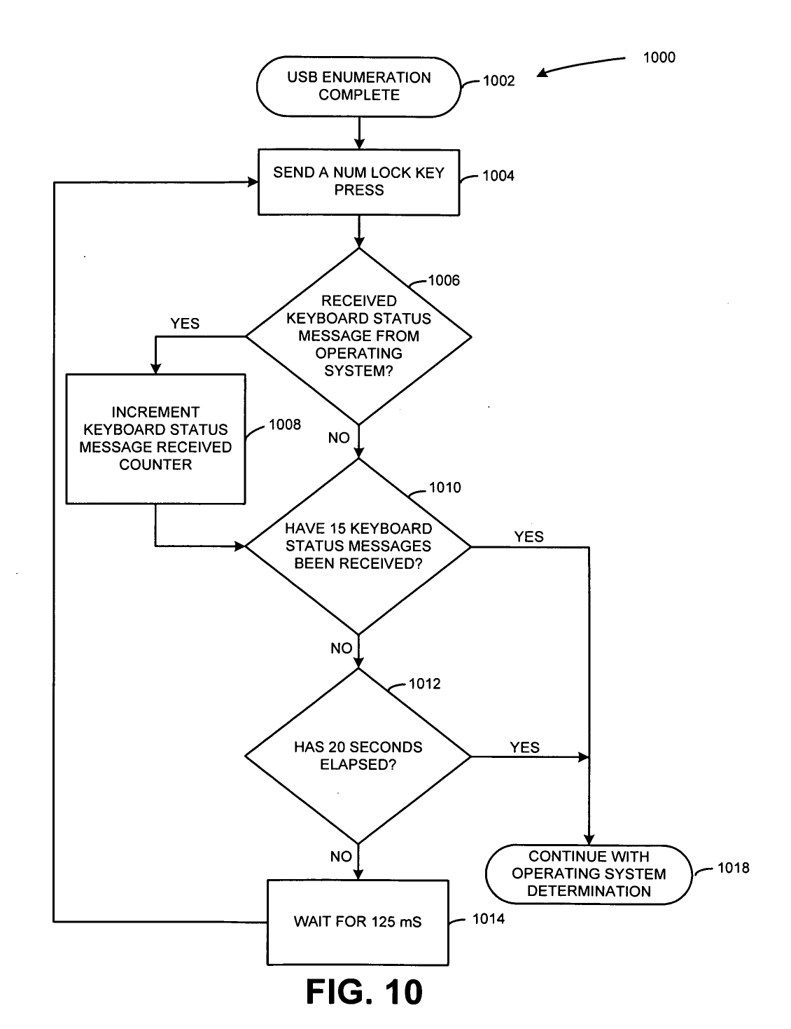

With reference to FIG. 10, exemplary operations 1000 are illustrated for determining when an operating system installed on the host computing device 101 is ready to communicate with the RF tag analyzer 102. Exemplary operations 1000 are capable of being performed by the communication module 136 of FIG. 1. The method begins in 1002. For example, the method may begin as part of the enumeration process of the RF tag analyzer with the host 101, where the RF tag analyzer 102 is a USB keyboard emulator.

The method continues in 1004 where a number lock key is emulated and presented to the host 101. In 1006 a determination is made as to whether a keyboard status message from the operating system of the host 101 has been received. This is similar to 804 in FIG. 8. If the determination is positive, a counter is incremented in 1008. If the determination is negative, it is determined whether 15 keyboard status messages have been received 1010. By definition the first pass through method 1000 will result in a negative determination at 1010. In such instances, the method continues to 1012 where it is determined whether a predetermined amount of time (e.g., 20 seconds) have elapsed since the first number lock key emulation was sent to the host 101 as part of 1004. If the determination is negative, the method continues in 1014 where the method waits for a second predetermined amount of time (e.g., 125 ms) and then repeats itself at 1004.

If the 15 keyboard status messages have been receive at determination 1010, it is determined that the operating system of the host 101 is ready to communicate with the RF tag analyzer 102 and the method continues to 1018. In one embodiment, 1018 starts the method described with respect to FIG. 9.

If 15 keyboard status messages have not been received at determination 1010 but 20 seconds have elapsed since the first num lock key emulation in 1004, it is similarly determined that the operating system of the host 101 is ready to communicate with the RF tag analyzer 102 and the method similarly continues to 1018.

By following the methods set forth in FIG. 10, the RF tag analyzer 102 will not power up and start transmitting data and signals (e.g., signal 121) to the host 101 before the operating system is ready for such communications. One of ordinary skill in the art will recognize that the number of keyboard status messages received as a condition to 1010 and the amount of time set forth in 1012 and 1014 are simply exemplary and that other values can be chosen and still be encompassed by the present disclosure.

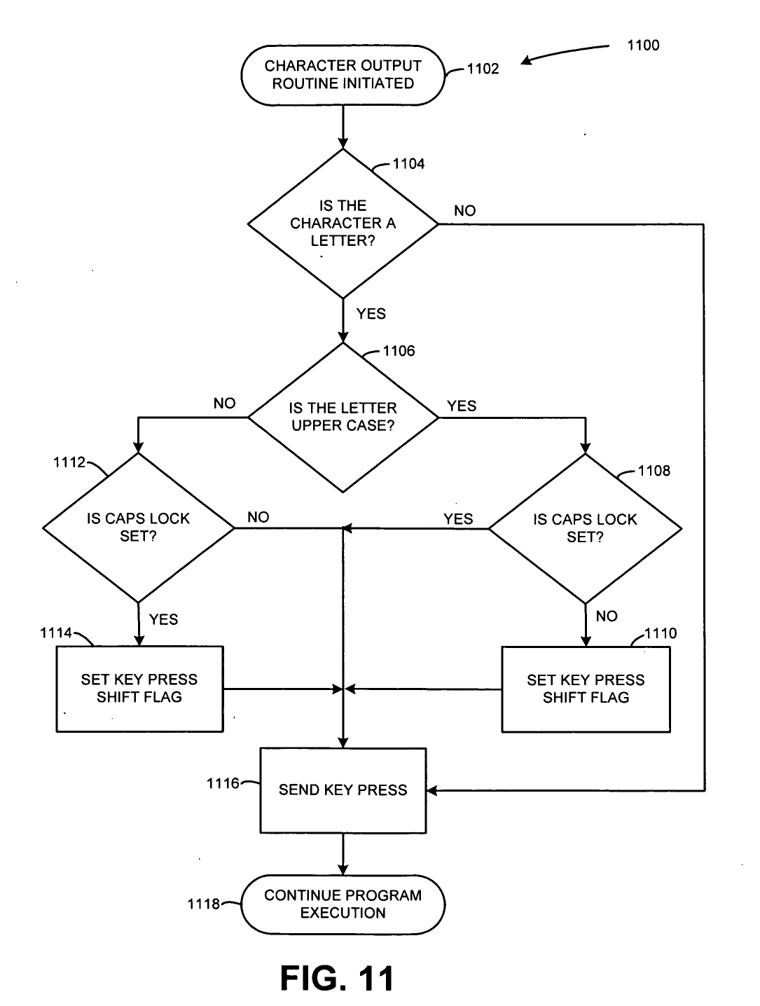

With reference to FIG. 11, exemplary operations 1100 for ensuring that output signals, e.g., from the RF tag analyzer 102 to a host computing device 101 are in the appropriate case (e.g., upper case or lower case) are illustrated. Exemplary operations 1100 are capable of being performed by the communication module 136 of FIG. 1. The method begins in 1102 where an intended output signal is generated. The method continues in 1104 where it is determined if a particular character in the intended output signal represents a letter. If the determination is negative, the method continues with 1116 where the RF tag analyzer 102 emulates the keystroke associated with the character (e.g., as a USB key press if the RF tag analyzer 102 is a USB keyboard emulator).

If, however, the determination is positive, then the character is a letter and the method continues to 1106 where it is determined if the letter is upper case. If the determination is positive, the method continues in 1108 where it is determined if the caps lock is set with the operating system. If the determination is no, then the a shift flag is set or pressed in order to create an upper case letter in the output signal. The method then continues with 1116 where the letter is “pressed”. Because of the shift flag, the letter press results in an upper case letter. If, however, the determination in 1108 is yes, then the method continues in 1116 and the letter is pressed to create an upper case letter.

If determination 1106 is negative (i.e., the letter is lower case), then the opposite process is followed to ensure that a lower case letter is created at 1116. For example, at 1112 a determination is made to determine whether the caps lock is set. If the determination is negative, the character key is simply pressed in 1116. If the determination is positive, the shift flag is pressed in 1114 and then the character key is pressed in 1116. The method concludes in 1118 where, for example the RF tag analyzer 102 sends a signal 121 using the appropriate case (lower or upper) as intended by the tag type analyzer 102 regardless of a cap locks setting in the operating system of the host 101.

As will be recognized by one having ordinary skill in the art, functional blocks and signals illustrated in the FIGS. in dashed lines are optional features of the claimed invention.

As noted above, the method and apparatus provide, among other advantages, an end user and third parties wishing to support RFID tags an easy way to determine what type of RFID tag the end user possesses. The analysis module uses a multi modulation detection circuit (amplitude, frequency and phase) to determine the technology used in the target card and reports the results to the user either as simple USB keystrokes, as serial data sent to a terminal application or through a helper application. In another embodiment, a method and apparatus autotypes (e.g., autoconfigures) itself in order to read RFID tags having different RFID tag types and/or technologies. Furthermore, because the method and apparatus can operate with multiple RFID tag types and/or technologies, there is no need for multiple card readers, which can reduce, among other things, inventory and/or manufacturing costs. Other advantages will be recognized by those of ordinary skill in the art.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims. In addition, unless stated otherwise, terms such as “first” and “second” are used to arbitrarily distinguish between the elements such terms describe. Thus, these terms are not necessarily intended to indicate temporal or other prioritization of such elements. The term coupled, as used herein, is defined as connected, although not necessarily directly, and not necessarily mechanically. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. The terms a or an, as used herein, are defined as one or more than one.

1. An apparatus for use in interrogating a radio frequency (“RF”) signal, comprising:
a reader module operative to determine transmitted radio frequency identification (“RFID”) information associated with a RF signal based on tag type parameters associated with a RFID tag type; and
a validation module operative to compare at least a portion of the transmitted RFID information with an expected characteristic associated with the RFID tag type and to determine if the RF signal was transmitted by a RFID tag associated with the RFID tag type.

2. The apparatus of claim 1, wherein reader module comprises a demodulator module operative to demodulate the RF signal based on the tag type parameters associated with the RFID tag type and to produce the transmitted RFID information.

3. The apparatus of claim 1, wherein the reader module comprises:
a demodulator module operative to demodulate the RF signal based on the tag type parameters and to produce a demodulated RF signal; and
a decoder module operative to decode the demodulated RF signal based on the tag type parameters and to produce transmitted RF information.

4. The apparatus of claim 2, wherein the demodulator module demodulates the RF signal using one of: an amplitude shift key demodulating scheme, a phase shift keying demodulation scheme, and a frequency shift keying demodulation scheme.

5. The apparatus of claim 3, wherein:
the demodulator module demodulates the RF signal using one of: an amplitude shift key demodulating scheme, a phase shift keying demodulation scheme, and a frequency, shift keying demodulation scheme, and
the decoder module decodes the demodulated RF signal using one of: non-return-to-zero inverted decoding scheme and a Manchester decoding scheme.

6. The apparatus of claim 1, further comprising a tag type selector module operative to generate an output signal representative of the RFID tag in response to the validation module determining that the RF signal was transmitted by the RFID tag associated with the RFID tag type.

7. The apparatus of claim 6, wherein the output signal includes one or more of the following information:
textual information describing the type of RFID tag type;
part number information associated with a RFID reader that can read. RF signals produced by the RFID tag type;
information regarding the transmitted RFID information; and
the transmitted RFID information.

8. The apparatus of claim 6, wherein the apparatus is a keyboard emulator and the output signal is a data stream of keystroke information.

9. The apparatus of claim 1, further comprising a tag type selector module operative to determine other tag type parameters associated with another RFID tag type in response to the validation module determining that the RF signal was not transmitted by the RFID tag associated with the RFID tag type.

10. The apparatus of claim 9, wherein the tag type selector module is operative to access memory to determine the other tag type parameters associated with the another RFID tag type.

11. The apparatus of claim 9, wherein:
the reader module is further operative to determine other transmitted RFID information associated with the RF signal based on the other tag type parameters associated with the another RFID tag type, and
the validation module is further operative to compare at least a portion of the other transmitted RFID information with another expected characteristic associated with the other RFID tag type and to determine if the RF signal was transmitted by a RFID tag associated with the other RFID tag type.

12. The apparatus of claim 1, further comprising a tag type selector module operative to configure an output signal including information indicating that the RFID signal was not capable of being read in response to the validation module determining that the RFID signal was not transmitted by the RFID tag associated with the RFID tag type.

13. The apparatus of claim 1, further comprising a tag type selector operative to configure an output signal including information indicating that the RF signal should be analyzed by a RFID helper module associated with a host computing device in response to the validation module determining that the RF signal was not transmitted by the RFID tag associated with the RFID tag type.

14. The apparatus of claim 1, wherein the tag type parameters comprises:
a demodulation type needed to demodulate a RF signal associated with the RFID tag type; and
a carrier frequency used by the RFID tag type to produce the RFID signal.

15. The apparatus of claim 14, wherein the tag type parameters further comprise:
a encoding type needed to decode the demodulated RF signal associated with the RFID tag type.

16. A method for interrogating a radio frequency (“RF”) signal, comprising:
determining, by a reader module, transmitted radio frequency identification (“RFID”) information associated with a RF signal based on tag type parameters associated with a RFID tag type;
comparing, by a validation module, at least a portion of the transmitted RFID information with an expected characteristic associated with the RFID tag type; and
determining, by the validation module, if the RF signal was transmitted by a RFID tag associated with the RFID tag type.

17. The method of claim 16, wherein determining the transmitted RFID information comprises demodulating the RF signal, by the reader module, based on the tag type parameters associated with the RFID tag type to produce the transmitted RFID information.

18. The method apparatus of claim 16, wherein determining the transmitted RFID information comprises:
demodulating the RF signal, by the reader module, based on the tag type parameters to produce a demodulated RF signal; and
decoding the demodulated RF signal, by the reader module, based on the tag type parameters to produce the transmitted RFID information.

19. The method of claim 16, further comprising generating, by a tag type selector module, an output signal including information associated with the RFID tag in response to determining that the RF signal was transmitted by the RFID tag associated with the RFID tag type.

20. The method of claim 19, wherein the output signal includes one or more of the following information:
textual information describing the type of RFID tag type;
part number information associated with a RFID reader that can read RF signals produced by the RFID tag type;
information regarding the size of the transmitted RFID information; and
the transmitted RFID information.

21. The method of claim 16, further comprising:
determining, by a tag type selector module, other tag type parameters associated with another RFID tag type in response to determining that the RF signal was not transmitted by the RFID tag associated with the RFID tag type;
determining, by the reader, module, other transmitted RFID information associated with the RF signal based on the other tag type parameters associated with the another RFID tag type;
comparing, by the validation module, at least a portion of the other transmitted RFID information with another expected characteristic associated with the other RFID tag type; and
determining, by the validation module, if the RF signal was transmitted by a RFID tag associated with the other RFID tag type.

22. The method of claim 16, further comprising configuring, by a tag type selector module, an output signal including information indicating:
that the RF signal was not capable of being read in response to determining that the RF signal was not transmitted by the RFID tag associated with the RFID tag type, and
that the RF signal should be analyzed by a RFID helper module associated with a host computing device in response to determining that the RF signal was not transmitted by the RFID tag associated with the RFID tag type.

23. A computer readable medium comprising instructions that when executed by at least one processor cause the at least one processor to:
determine transmitted radio frequency identification (“RFID”) information associated with a radio frequency (“RF”) signal based on tag type parameters associated with a RFID tag type;
compare at least a portion of the transmitted RFID information with an expected characteristic associated with the RFID tag type; and
determine if the RF signal was transmitted by a RFID tag associated with the RFID tag type.

24. The computer readable medium of claim 23, wherein the instructions when executed by the at least one processor further cause the at least one processor to determine the transmitted RFID information by demodulating the RF signal based on the tag type parameters associated with the RFID tag type to produce the transmitted RFID information.

25. The computer readable medium apparatus of claim 23 wherein the instructions when executed by the at least one processor further cause the at least one processor to determine the transmitted RFID information by:
demodulating the RF signal based on the tag type parameters to produce a demodulated RF signal; and
decoding the demodulating RF signal based on the tag type parameters to produce the transmitted RFID information.

26. The computer readable medium of claim 23, wherein the instructions when executed by the at least one processor further cause the at least one processor to generate an output signal including information associated with the RFID tag in response to determining that the RF signal was transmitted by the RFID tag associated with the RFID tag type.

27. The computer readable medium of claim 26, wherein the output signal includes one or more of the following information:
textual information describing the type of RFID tag type;
part number information associated with a RFID reader that can read RF signals produced by the RFID tag type;
information regarding the size of the transmitted RFID information; and
the transmitted RFID information.

28. The computer readable medium of claim 23, wherein the instructions when executed by the at least one processor further cause the at least one processor to:
determine other lag type parameters associated with another RFID tag type in response to determining that the RF signal was not transmitted by the RFID tag associated with the RFID tag type;
determine other transmitted RFID information associated with the RF signal based on the other tag type parameters associated with the another RFID tag type;
compare at least a portion of the other transmitted RFID information with another expected characteristic associated with the other RFID tag type; and
determine if the RF signal was transmitted-by a RFID tag associated with the other RFID tag type.

29. The computer readable medium of claim 23, wherein the instructions when executed by the at least one processor further cause the at least one processor to configure an output signal including information indicating:
that the RF signal was not capable of being read in response to determining that the RF signal was not transmitted by the RFID tag associated with the RFID tag type, and
that the RF signal should be analyzed by a RFID helper module associated with a host computing device in response to determining that the RF signal was not transmitted by the RFID tag associated with the RFID tag type.

30. A system for use in interrogating a radio frequency (“RF”) signal, comprising:
a reader module operative to determine transmitted radio frequency identification (“RFID”) information associated with a RF signal based on tag type parameters associated with a RFID tag type;
a validation module operative to compare at least a portion of the transmitted RFID information with an expected characteristic associated with the RFID tag type and to determine if the RF signal was transmitted by a RFID tag associated with the RFID tag type; and
a host computing device operative to receive an output signal including information associated with the RFID tag in response to determining that the RF signal was transmitted by the RFID tag associated with the RFID tag type.

31. The system of claim 30, wherein the reader module and the validation module comprise constituent parts of a keyboard emulator and wherein the output signal is an output signal of the keyboard emulator and includes a data stream of keystroke information.

32. An apparatus for use in interrogating a radio frequency (“RF”) signal, comprising:
a demodulation validation module associated with a host computing device operative to determine if a demodulated RF signal from a radio frequency identification (“RFID”) tag reader is valid;
a report module associated with the host computing device operative to generate a signal that:
includes transmitted RFID information associated with the RF signal as a raw data stream if the demodulated RF signal is valid; and
indicating that the RFID tag cannot be read if the demodulated RF signal is not valid.

33. An apparatus for use in interrogating a radio frequency (“RF”) signal, comprising:
a demodulation validation module associated with a host computing device operative to determine if a demodulated RF signal from a radio frequency identification (“RFID”) tag reader is valid;
a decoder validation module associated with the host computing device that, in response to the demodulation validation module determining that the demodulated RF signal is valid, is operative to determine if the demodulated RF signal is capable of being decoded; and
a report module associated with the host computing device operative to generate a signal that:
includes transmitted RFID information associated with the RF signal as a raw data stream if the demodulated RF signal is valid and the demodulated RF signal is capable of being decoded; and
indicating that the RFID tag cannot be read if at least one of the following is determined: the demodulated RF signal is not valid and the demodulated RF signal is not capable of being decoded.

34. The apparatus of claim 33, wherein the report module is operative to transmit the generated signal as a data stream in an email addressed to a pre-configured email recipient.

35. An apparatus for use in interrogating a radio frequency (“RF”) signal from a radio frequency identification (“RFID”) tag, comprising:
a relationship module that is operative to determine a relationship between an expected data result from the RF signal and an actual data result from the RF signal;
a configuration module that is operative to configure a configuration file with an algorithm based on the determined relationship, wherein the configuration file is capable of being used to configure a RFID reader to output the expected data result each time the RFID reader obtains the actual data result from the RFID tag.

36. An apparatus for use in interrogating a radio frequency. (“RF”) signal from a radio frequency identification (“RFID”) tag, comprising:
a relationship module that is operative to determine a relationship between an expected data result from the RF signal and an actual data result from the RF signal;
a configuration module that is operative to configure a RFID reader based on the determined relationship to output the expected data result each time the RFID reader obtains the actual data result from the RFID tag.
